(19) United States
(12) Patent Application Publication
(10) Pub. No.: US 2006/0278573 A1
(43) Pub. Date: Dec. 14, 2006

(54) Drainage box

(76) Inventor: Donnell Robinson, Oakland, CA (US)

Correspondence Address: Donnell Robinson, 825 52nd Street, Oakland, CA, 94608, US

(21) Appl. No.: 11/153,486

(22) Filed: Jun. 14, 2005

(51) Int. Cl. B01D 25/00

(52) U.S. Cl. 210/460; 210/162; 210/163; 52/12; 52/16

(57) ABSTRACT

A drainage box is provided for use in protecting gutter drainpipes from clogging. An exemplary embodiment of the drainage includes a drainpipe portion for removably inserting into a drainpipe, and a filter attached to the drainpipe portion, wherein the filter has at least three plane sides. The filter includes a plurality of the apertures in at least one of the sides for allowing liquid to pass-through the at least one side of the filter and down the drainpipe portion, while filtering debris including leaves. In further embodiments, the filter is made of a nonmetal material and optional includes a plurality of fins on at least one of the sides that protrude from a surface of the filter for spacing debris away from the apertures, thereby reducing the chance that the apertures become clogged.

### FIELD OF THE INVENTION

The present invention relates to a drainpipe protection apparatus, and more particularly to an improved drainage box.

### BACKGROUND OF THE INVENTION

Gutters and downspouts are easily clogged by leaves and debris. There are many types of gutter protection systems in use today. Some types of gutter protection systems attach to the roofing and attempt to block debris from entering the gutter entirely, while others are inserted into the gutter an attempt to block debris from entering drainpipes or downspouts of the gutter.

Examples of gutter systems that attempt to block debris from entering drainpipes include gutter pumps and downspout strainers. Gutter pumps help keep debris out of the drain by fitting into standard drainpipes and working as a self priming siphon once submerged. Gutter pumps protect drainpipes in two ways. First, the gutter pump blocks debris from clogging the downspout; meanwhile its self-priming siphon pulls water underneath to keep the gutter system functioning. On disadvantage of the gutter pump is that it has moving parts, which can become inoperable, and are relatively expensive.

Downspout strainers, in contrast, are made of expanded metal mesh or simple metal wires and are inserted over drainpipe openings in gutters to keep the drainpipes and underground drainage from clogging. Downspout strainers are commonly coned or domed shaped and are typically made from some type of metal material including aluminum, steel and copper.

Although gutter pumps and downspout strainers are widely used, experience has shown that these devices are largely ineffective. That is, despite use of these devices, the drainpipes that are supposedly protected by these devices still become clogged by leaves and debris.

This can be attributed to the following drawbacks of these devices. One drawback is that because downspout strainers are made of thin metal, they rust and become weak, and are therefore collapsible by debris over time. Another drawback is that the wires of the strainers are often spaced too far apart and allow debris to filter through the cone itself and into the drainpipe. Accordingly, a need exist for an improved drainpipe protection apparatus.

### BRIEF SUMMARY OF THE INVENTION

The present invention provides a drainage box for use in protecting gutter drainpipes from clogging. An exemplary embodiment of the drainage includes a drainpipe portion for removably inserting into a drainpipe, and a filter attached to the drainpipe portion. In one embodiment, the filter has at least three plane sides. The filter further includes a plurality of the apertures in at least one of the sides for allowing liquid to pass-through and down the drainpipe portion, while filtering debris including leaves. In further embodiments, the filter is made of a nonmetal material and optional includes a plurality of fins on at least one of the sides that protrude from a surface of the filter for spacing debris away from the apertures, thereby reducing the chance that the apertures become clogged.

According to method and apparatus disclosed herein, the drainage box of the present invention has no moving parts, requires no tools to put together, requires no tools to insert, requires no fasteners to hold in place, has no nuts and bolts, has no rings, and is made of a material that does not rust.

### BRIEF DESCRIPTION OF SEVERAL VIEWS OF THE DRAWINGS

FIG. 1 is a block diagram illustrating an exemplary preferred embodiment of the drainage box of the present invention.

FIG. 2 is a block diagram illustrating the drainage box inserted in a conventional gutter, which is shown by the dashed lines.

FIG. 3 is a block diagram showing an isometric view of a drainage box according to a second preferred embodiment.

### DETAILED DESCRIPTION OF THE INVENTION

The present invention relates to a drainpipe protection apparatus. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a non metal drainpipe protection apparatus, referred to as a drainage box that is inserted into a drainpipe and includes several apertures that are sized to significantly reduce the amount debris, such as leaves, from entering the drainpipe. The drainbox also may include fins that reduce the amount of debris that accumulates against the apertures to prevent the apertures themselves from clogging.

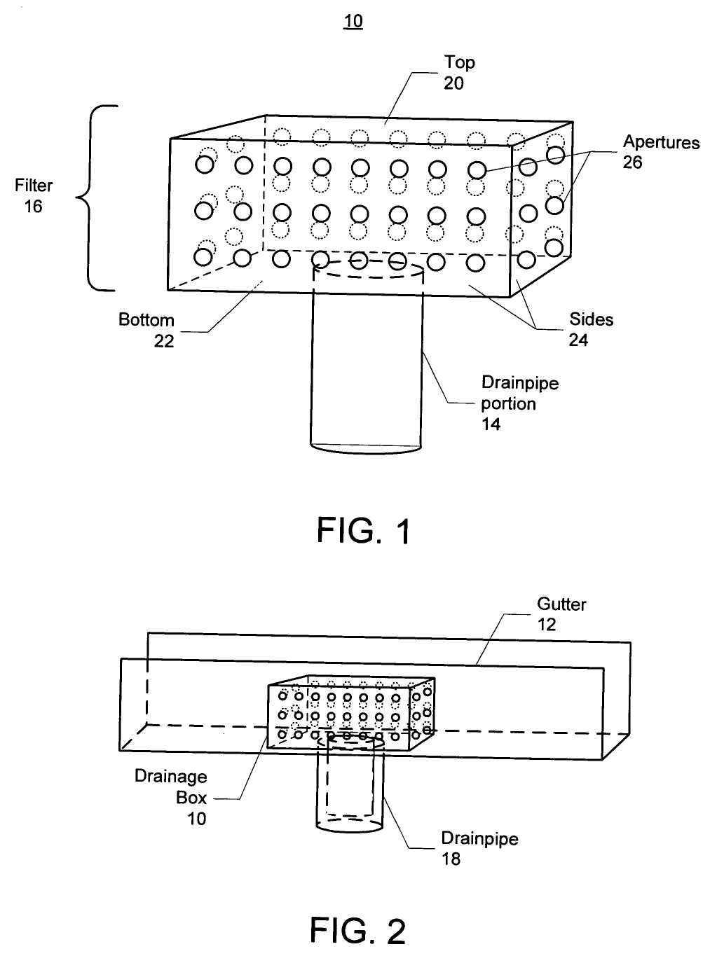

FIG. 1 is a block diagram illustrating an exemplary preferred embodiment of the drainage box 10 of the present invention. FIG. 2 is a block diagram illustrating the drainage box 10 inserted in a conventional gutter 12. Referring to both FIGS. 1 and 2, the drainage box 10 basically comprises a drainpipe portion 14 and a filter 16 that is attached to the drainpipe portion 14. The drainage box 10 is placed into the gutter 12 by removably inserting the drainpipe portion 14 into the drainpipe 18 of the gutter 12, holding the drainage box 10 in place. Once the drainpipe portion 14 is fully inserted into the drainpipe 18, the filter 16, which is larger than the dimensions of the drainpipe 18 rests on the bottom of the gutter between the gutter sidewalls. Thus, no tools, tie-downs, or bolts are needed to insert and hold the drainage box in place.

In the embodiment shown, the filter 16 includes a top 20, a bottom 22, and four sides 24, where each of the sides 24 includes a plurality of apertures 26 for allowing liquid flowing through the gutter 12 to pass-through the sides 24 of the filter 16 and down the drainpipe portion 14 into the drainpipe 18, while filtering debris including leaves. In the embodiment shown, the filter 16 has a rectangular shape where the long sides of the rectangle are placed parallel to the longitudinal axis of the gutter. Although the filter 16 is shown with apertures 26 on each of the four sides 24, only the short sides of the rectangle that are in the path of the water flow through the gutter 12 may include the apertures 26.

In addition, although the drainage box 10 is shown with a top 20 and four plane sides 24, the drainage box 10 may be constructed with as few as three sides (i.e., a triangle having no top). In a preferred embodiment, each of the sides 24 are flat, although the sides 24 may also have a concave or convex shape. No matter the shape of the sides 24, each of the sides preferably lies substantially in its own plane. In an alternative embodiment, the filter 16 with the apertures 26 may be fabricated as an arch having flat sides that will be placed adjacent to the gutter sidewalls. The filter 16 may also be shaped as a round dome, or a circle with a flat top.

In the exemplary preferred embodiment no matter the shape of the filter 16, the portions of the drainage box 10 containing the apertures 26 are made of solid pieces of nonmetal material in which the apertures are then cut out. In a preferred embodiment, the pieces of nonmetal material are glued together to form the filter 16, and the filter 16 is also glued to the drainpipe portion 14. In an alternative embodiment, the entire drainage box 10 or the two main components, the filter 16 and drainpipe portion 14, may be constructed from a solid piece of nonmetal material. Examples of nonmetal materials include fiberglass, ceramic, and plastic, for instance. In one preferred embodiment, the filter 16 and drainpipe portion 14 are constructed of ¼″ thick fiberglass pieces. Because no metal is used, the drainage box is rustproof and therefore relatively non-collapsible overtime. Furthermore, no nuts or bolts are required to assemble the drainage box 10.

In the exemplary preferred embodiment, the apertures 26 cut into the sides 24 of the filter 16 are shaped as circles. In alternative embodiment, however, the apertures 26 may be other shapes, and the different aperture shapes may be utilized to on the same drainage box 10. For example, the drainage box 10 may include apertures 26 comprising any combination of circles, squares, rectangles, trapezoids, and ovals. Whatever aperture shape is used, however, what is important is that the apertures 26 be sized sufficiently small to prevent debris, primarily leaves, from entering the filter 16. In a preferred embodiment, the apertures are ¼ inch in diameter, although the size of the apertures may vary depending on the particular side in which the aperture is located. For example, the sides of the filter that are parallel to or adjacent to the gutter 12 side walls may have apertures that are smaller than the sides that are in the path of water flow through the gutter. Thus, only liquid and perhaps small particles can pass-through the apertures 26 to enter the drainpipe 18, but nothing sufficient to clog the drainpipe.

In a preferred embodiment, the drainpipe portion 14 is round in shape, but may also be formed in other shapes such as a square, a rectangular, or an oval, to fit the shape of the drainpipe 18. The drainpipe portion 14 may be approximately 3-5 inches in length, and may be cut to fit prior to installation if it is too long. In one embodiment, the drainpipe portion 14 is centrally located under the filter 16. But for drainpipes that are located at the end of gutters, the drainpipe portion 14 may be located under either end of the filter 12 for corner placement in the gutter 12.

In the preferred embodiment of the present invention, the apertures 26 in the filter 16 effectively prevent leaves from passing through the sides of the filter 12, but nothing prevents debris and leaves from pressing against the surface of the drainage box 10 and over the apertures 26. The second embodiment of the drainage box significantly reduces the amount of large debris that can reach the side of the filter 16.

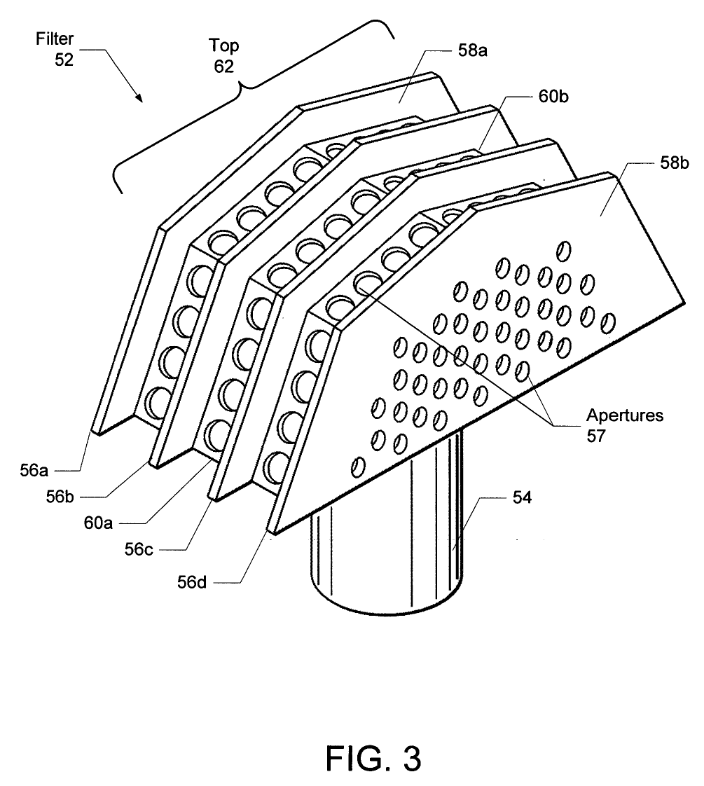

FIG. 3 is a block diagram showing an isometric view of a drainage box according to a second preferred embodiment. Similar to the first embodiment, the drainage box 50 of the second preferred embodiment includes a filter 52 and a drainpipe portion 54. However, the drainage box 50 further includes a plurality of fins 56a, 56b, 56c, and 56d (collectively referred to as fins 56) that protrude from the surface of the filter 52 for spacing debris away from the apertures 57 in the surface of the filter 52, thereby reducing the chance that the apertures 57 become clogged. In the embodiment shown, the filter 52 includes two long sides 58a and 58b that face the gutter sidewalls, two short sides 60a and 60b that are perpendicular to the longitudinal axis of the gutter, and a top 62, which in the embodiment shown comprises two pieces. Four fins 56 span the length of the filter 52 and protrude perpendicular to the normals of each of the two short sides 60 and the topsides 62 of the filter 52. In addition, the fins 56a and 56d are formed by making the sidewalls of the filter 52 longer than the body of the filter. Of course, the fins may extend across the sides of the filter either vertically or horizontally. In a further embodiment, the fins 56 may be formed into any shape that protrudes from the surface of the filter, such as blocks, circles or noncontiguous rectangles, for example.

A drainage box for use in gutters has been disclosed. According to the present invention, the drainage box, which only includes a filter and a drainage portion, has the following advantages over conventional device: the drainage box requires no tools to put together, requires no tools to insert, requires no fasteners to hold in place, has no moving parts, has no nuts and bolts, is made of a material that does not rust, and has no rings.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A drainage box, comprising:
a drainpipe portion for removably inserting into a drainpipe;
a filter attached to the drainpipe portion, the filter having at least three plane sides; and
a plurality of the apertures in at least one of the sides for allowing liquid to pass-through the at least one side of the filter and down the drainpipe portion, while filtering debris including leaves.

2. The drainage box of claim 1 wherein the drainage box is made of nonmetal material.

3. The drainage box of claim 2 wherein the nonmetal material comprises at least one of fiberglass, ceramics, and plastic.

4. The drainage box of claim 3 wherein the drainage box is constructed from separate pieces of the nonmetal material that are glued together.

5. The drainage box of claim 1 wherein the filter further includes a plurality of fins on at least one of the sides that protrude from a surface of the filter for spacing debris away from the apertures.

6. The drainage box of claim 1 wherein the sides are any combination of being flat, concave, and convex in shape.

7. The drainage box of claim 6 wherein each of the sides lies substantially in its own plane.

8. The drainage box of claim 1 wherein the drainage box is placed into the gutter by removably inserting the drainpipe portion into a drainpipe of the gutter, thereby holding the drainage box in place.

9. The drainage box of claim 8 wherein the filter as a dimension larger than a dimension of the drainpipe, such that once the drainpipe portion is fully inserted into the drainpipe, the filter rests on a bottom of the gutter between side walls of the gutter.

10. The drainage box of claim 9 wherein the filter includes a top, a bottom, and four plane sides forming a rectangle, wherein long sides of the rectangle are placed parallel to the longitudinal axis of the gutter, and at least the short sides of the rectangle include the apertures.

11. The drainage box of claim 1 wherein the apertures are sized sufficiently small to prevent debris, primarily leaves, from entering the filter.

12. The drainage box of claim 11 wherein the apertures are ¼″ in diameter.

13. The drainage box of claim 11 wherein the apertures in the at least one side of the filter are shaped as circles.

14. The drainage box of claim 13 wherein the apertures comprise any combination of circles, squares, rectangles, trapezoids, and ovals:

15. The drainage box of claim 1 wherein the drainpipe portion is shaped to fit a shape of a drainpipe to which it is to be inserted.

16. The drainage box of claim 15 wherein the drainpipe portion is centrally located under the filter.

17. The drainage box of claim 16 wherein the drainpipe portion is located under an end of the filter for corner placement in a gutter.

18. A drainage box, comprising:
a drainpipe portion for removably inserting into a drainpipe;
a filter attached to the drainpipe portion, the filter made of at least one piece of a nonmetal material; and
a plurality of the apertures in the filter for allowing liquid to pass-through the filter and down the drainpipe portion, while filtering debris.

19. The drainage box of claim 17 wherein the filter further includes a plurality of fins on at least one side that protrude from a surface of the filter for spacing debris away from the apertures.

20. The drainage pipe of claim 19 wherein the apertures are cut out of the nonmetal material and sized sufficiently small to prevent debris, including leaves, from entering the filter.

21. The drainage pipe of claim 20 wherein the nonmetal material comprises at least one of fiberglass, ceramics, and plastic.

22. The drainage pipe of claim 21 wherein the filter is shaped as a dome.

23. The drainage pipe of claim 21 wherein the filter is shaped as a circle with a flat top.

24. The drainage pipe of claim 21 wherein the filter includes at least three sides.

25. The drainage pipe of claim 21 wherein the filter includes at least four sides, a top, and a bottom.

26. The drainage pipe of claim 21 wherein the filter is shaped as an arch.

27. The drainage pipe of claim 26 wherein the filter further includes two flat sides for placing adjacent to sidewalls of a gutter.
